(19) United States
(12) Patent Application Publication
(10) Pub. No.: US 2008/0148497 A1
(43) Pub. Date: Jun. 26, 2008

(54) Dispersant for Polyester Oligomers

(75) Inventor: Manfred Jungen, Lauwil (CH)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Virgin Islands (GB)

(21) Appl. No.: 11/793,687

(22) PCT Filed: Dec. 21, 2005
(86) PCT No.: PCT/EP2005/057062

§ 371 Date: Jun. 21, 2007

(30) Foreign Application Priority Data
Dec. 23, 2004 (EP) 04030576.5

(51) Int. Cl. C09B 67/00

(52) U.S. Cl. 8/557

(57) ABSTRACT

The present invention relates to the use of mono- or polyunsaturated alpha-olefÊnsulphonates as an active substance alone or in combination with further codispersants for removing polyester oligomers from fibres, fabrics or textile-dyeing machines, for preventing deposits or for deweighting polyester fibres.

The present invention relates to the use of alpha-olefinsulphonates as a dispersant for polyester oligomers.

Polyester fibres are produced by a process which gives rise, not only in the fibre material but also on the fibre surface, to cyclic or linear oligomers which can lead to various problems in the course of the later processing of the fibres. Especially the cyclic trimers of polyethylene terephthalate present difficulties. These oligomers are not dyeable and possess only minimal solubility in water. They therefore crystallize on contact with the aqueous dyeing liquor and cause troublesome deposits on the surface of the fibre and in dyeing machines. As well as to possible unlevelness of the dyeing, these deposits can lead to soiling, dust and damage of sensitive parts in the course of the further processing.

Hodul et al. review the matter in Vlákna a textil 5(1-2), 12-18, 1998. It was found that sodium laurylsulphate shows some effect as a dispersant.

WO 2004/090222 A2 describes a textile auxiliary based on 2-acrylamido-2-methyl-propanesulphonic acid (AMPS) and a polymer based on acrylic acid and/or maleic acid as an oligomer dispersant.

In the textile industry, however, there continues to be a demand for suitable ways to eliminate these oligomers. It has now been found that, surprisingly, certain alpha-olefinsulphonates, which may be poly- as well as monounsaturated, constitute excellent dispersants for polyester oligomers, either alone or in combination with further codispersants. This surprising dispersing effect removes the undesirable oligomers from the fibre or the textile fabric, but also from the textile-dyeing machines, so that these are very simple and efficient to clean, or prevents the production of deposits in the first place. This good dispersing effect can also be utilized for deweighting.

The present invention accordingly provides for the use of mono- or polyunsaturated alpha-olefinsulphonates as an active substance alone or in combination with further codispersants for removing polyester oligomers from fibres, fabrics or textile-dyeing machines, for preventing deposits or for deweighting polyester fibres.

The alpha-olefinsulphonates are substances of the general formula (I)

R—CH═CH—CH₂—SO₃-M (I)
where
R is a linear or branched alkyl radical or a linear or branched, mono- or polyunsaturated alkenyl radical having 7 to 23 carbon atoms, and
M is hydrogen, an alkali metal, ammonium or substituted ammonium.

Preference is given to substances wherein
R is a linear alkyl radical or alkenyl radical having 11 to 15 carbon atoms, and
M is sodium or ammonium.

Particular preference is given to substances wherein
R is a linear alkyl radical having 11 to 15 carbon atoms, and
M is sodium.

Useful further codispersants include the following compounds: aryl or alkyl sulphonates and sulphates, for example cumenesulphonate, aromatic esters and amides, for example N-substituted phthalimides, benzyl benzoate and further benzoic esters, mono- or oligoesters of terephthalic acid with a polyol, ditto for phthalic acid and isophthalic acid, aryl alkoxylates, aryl-formaldehyde condensates sulphated and non-sulphated, phosphates and phosphonates of the aforementioned compounds, sulphated, sulphonated, phosphated, phosphonated olefin derivatives, for example oleyl alcohols or oleic acid derivatives.

The alpha-olefinsulphonates mentioned are known substances and are preparable by known methods.

The active substance can be used directly as such or else in aqueous mixture, in which case the aqueous mixture utilizes 10% to 40% by weight of active substance with or without up to 4% by weight of further additives.

Preferably, the aqueous mixture comprises 20% to 30% by weight of active substance and also, if appropriate, up to 2% by weight each of sodium cumenesulphonate, free oleic acid, sulphated oleic acid or other dispersing agents that are customary in the textile industry and known to one skilled in the art, or other auxiliary materials. A methylated phenol ethoxylate-formaldehyde condensate is used as a preferred further dispersing agent.

It may also be helpful in some instances for a compound of the formula (II)

R—C(OH)H—CH₂—CH₂—SO₃-M (II)
where
R is a linear or branched alkyl radical having 7 to 23 carbon atoms, and
M is hydrogen, an alkali metal, ammonium or substituted ammonium,
to be used as a further active substance, in which case the amount of (II) is in the range from 1% to 10% by weight of the amount of (I).

Preferably, in the formula (II),
R is a linear alkyl radical having 11 to 15 carbon atoms,
M is sodium, and
the amount of (II) is in the range from 1% to 5% by weight of the amount of (I).

The aqueous mixture can be added to the dyebath directly in a concentration of 0.5 to 4 ml/l and preferably in a concentration of 1 to 3 ml/l. Existing processes may be employed, for example the exhaust process, using a jigger, a winch beck or a jet-dyeing machine for woven and knitted material or in a dyeing apparatus for polyester yarn and also polyester staple. Customary further dyeing auxiliaries can be used alongside the dispersant of the present invention.

Since the deposition of polyester oligomers in textile-dyeing machines can lead to various problems, the surprisingly good dispersing effect described above constitutes a substantial technical benefit, since the active substance or its aqueous mixtures can thus also be used for cleaning the textile-dyeing machines. The machines can be treated under neutral, acidic or basic conditions, preferably they are boiled out in the additional presence of caustic soda and sodium hydrosulphite (or yet further auxiliary surfactants), which leads to complete removal of the polyester oligomers. But the use according to the present invention can also prevent the formation of deposits in the first place.

Furthermore, the alpha-olefinsulphonates described or their aqueous mixtures, if appropriate in the identified combination with a further active substance or further codispersants, can be used for deweighting. Deweighting is an alkaline pretreatment of the surface of polyester fibres whereby a controllable peeling effect is achieved, which leads to a silky, soft hand.

The examples which follow illustrate the invention.

### Test Method

The test method described in WO 2004/090222 appeared to be somewhat removed from actual commercial practice, which is why direct large-scale trials under industrial conditions were carried out. In each trial, about 50 kg of polyester yarn were exhaust dyed with various disperse dyes (liquor ratio 11.3:1; pH 4.5-5.5; bath temperature 80-135° C., reduction clearing with NaOH/sodium dithionite, neutralization with acetic acid).

A dispersant based on lauryl ether sulphate/aryl sulphonate was used as a comparison against the prior art.

### Results of Practical Trials

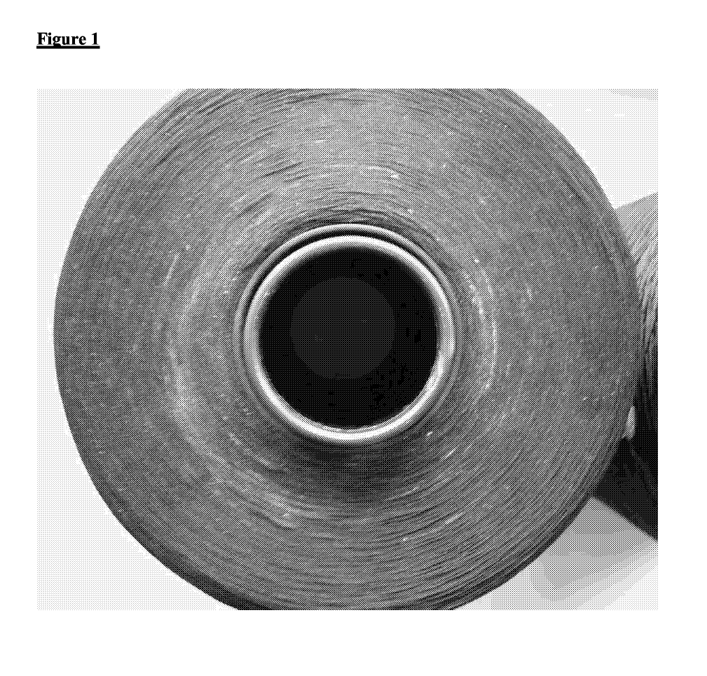

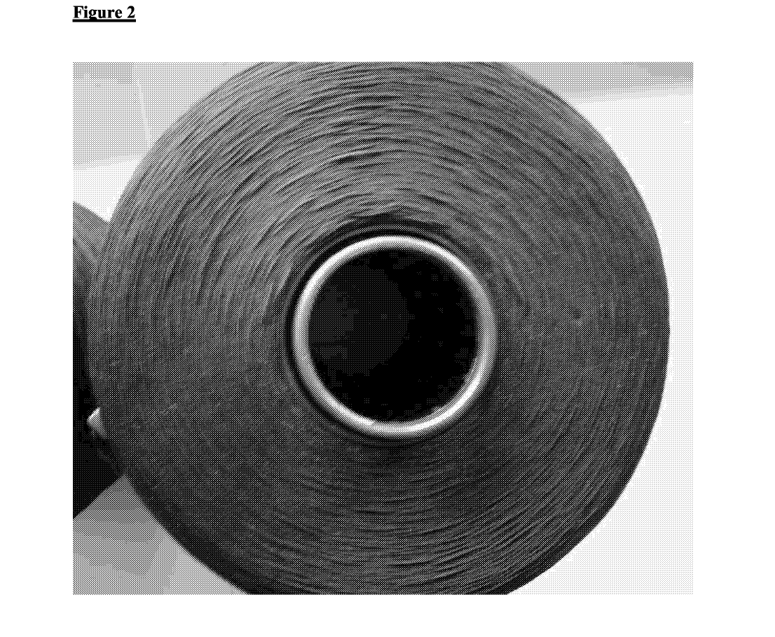

The comparative product showed distinct deposits on the surface of the dyed packages, whereas this was not the case with the dispersant of the present invention. This was particularly noticeable in the case of yarn packages dyed black. FIG. 1 shows distinct deposits on using the comparative dispersant. FIG. 2 shows that there are no deposits to be seen on the package surface when the dispersant of the present invention is used, all one can see is a uniformly black surface.

It was also determined that the dispersant of the present invention has no adverse effect on the light-fastness of polyester dyeings or on the dyed result (hue, bath exhaustion, for example).

1. A process for removing polyester oligomers from a fibre, a fabric, or a textile-dyeing machine, for preventing deposits or for deweighting polyester fibre comprising the step of adding at least one mono- or polyunsaturated alpha-olefinsulphonate or a mixture of both to a textile dyebath.

2. A process according to claim 1, wherein the at least one alpha-olefinsulphonate is a substance of the general formula (I)
R—CH═CH—CH₂—SO₃-M (I)
wherein
R is a linear or branched alkyl radical or a linear or branched, mono- or polyunsaturated alkenyl radical having 7 to 23 carbon atoms, and
M is hydrogen, an alkali metal, ammonium or substituted ammonium.

3. A process according to claim 2, wherein
R is a linear alkyl radical or alkenyl radical having 11 to 15 carbon atoms, and
M is sodium or ammonium.

4. A process according to claim 2, wherein
R is a linear alkyl radical having 11 to 15 carbon atoms, and
M is sodium.

5. A process according to claim 14, wherein the at least one codispersant is selected from the group consisting of: aryl or alkyl sulphonates and sulphates, aromatic esters and amides, aryl alkoxylates, aryl-formaldehyde condensates sulphated and non-sulphated, phosphates and phosphonates of the aforementioned compounds and sulphated, sulphonated, phosphated or phosphonated olefin derivatives.

6. A process according to claim 1, wherein the at least one mono- or polyunsaturated alpha-olefinsulphonate is in an aqueous mixture in a range of 10% to 40% by weight with 0% to 4% by weight of at least one further additive additives.

7. A process according to claim 6, wherein the aqueous mixture comprises 20% to 30% by weight of the at least one mono- or polyunsaturated alpha-olefinsulphonate or a mixture of both and 0% to 2% by weight each of sodium cumenesulphonate, free oleic acid, and sulphated oleic acid.

8. A process according to claim 2, further comprising the step of adding a compound of the formula (II)
R—C(OH)H—CH₂—CH₂—SO₃-M (II)
wherein
R is a linear or branched alkyl radical having 7 to 23 carbon atoms, and
M is hydrogen, an alkali metal, ammonium or substituted ammonium, with the amount of formula (II) being in the range from 1% to 10% by weight of the amount of formula (I).

9. A process according to claim 8, wherein
R is a linear alkyl radical having 11 to 15 carbon atoms, and
M is sodium, and wherein
the amount of formula (II) is in the range from 1% to 5% by weight of the amount of formula (I).

10. A process for removing polyester oligomers from a textile dyeing machine, comprising the step of treating a textile-dyeing machine with at least one mono- or polyunsaturated al ha-olefinsulphonate or aqueous mixtures thereof under a neutral, acidic or alkali.

11. A process for removing polyester oligomers from a fibre, a fabric or a textile-dyeing machine or for preventing deposits in a process for dyeing polyester fibre or material, comprising the step of adding 0.5 to 4 ml/l of an aqueous mixture comprising 10% to 40% by weight of at least one mono- or polyunsaturated alpha-olefinsulphonate and 0% to 4% by weight of at least one further additive, to the dyeing liquor.

12. A process according to claim 1, further comprising dyeing the fibre or fabric, wherein the dyeing is carried out in an exhaust process, and wherein the liquor ratio is in the range from 3:1 to 20:1, the pH is in the range from 3 to 7 and preferably in the range from 4 to 5.5, and the dyeing temperature is between 50° C. and 150° C.

13. A process according to claim 1, further comprising dyeing the fibre or fabric, wherein the dyeing is carried out a pH in the range from 7 to 11.

14. A process according to claim 1, further comprising the step of adding at least one codispersant to the dyebath.

15. A process according to claim 10, further comprising the step of adding at least one auxiliary selected from the group consisting of: caustic soda, sodium hydrosulphite, and a surfactant.

16. A process according to claim 12, wherein the liquor ratio is in the range from 5:1 to 13:1.

17. A process according to claim 12, wherein the liquor ratio is in the range from 6:1 to 11:1.

18. A process according to claim 12, wherein the pH is in the range from 4.0 to 5.5.

19. A process according to claim 12, wherein the dyeing temperature is between 95° C. and 140° C.

20. A process according to claim 12, wherein the dyeing temperature is between 110° C. and 135° C.

21. A process according to claim 13, wherein the pH is in the range from 8 to 10.

22. A fibre, a fabric, or a textile dyeing machine treated in accordance with the process according to claim 1.

23. A textile dyeing machine treated in accordance with the process according to claim 6.

24. A textile dyeing machine treated in accordance with the process according to claim 10.
